(19) United States
(12) Patent Application Publication
(10) Pub. No.: US 2019/0155092 A1
(43) Pub. Date: May 23, 2019

(54) METHOD FOR MANUFACTURING COLOR FILTER SUBSTRATE

(71) Applicant: Wuhan China Star Optoelectronics Technology Co., Ltd., Wuhan, Hubei (CN)

(72) Inventors: Yafeng LI, Wuhan, Hubei (CN); Jinfang WU, Wuhan, Hubei (CN)

(73) Assignee: Wuhan China Star Optoelectronics Technology Co., Ltd., Wuhan, Hubei (CN)

(21) Appl. No.: 15/738,041

(22) PCT Filed: Dec. 5, 2017
(86) PCT No.: PCT/CN2017/114528

§ 371 Date: Dec. 19, 2017

(30) Foreign Application Priority Data
Nov. 21, 2017 (CN) 201711161787.X

(51) Int. Cl. G02F 1/1335

(52) U.S. Cl. CPC G02F 1/133516; G02F 2201/52; G02F 1/133512

(57) ABSTRACT

The present invention provides a method for manufacturing a color filter substrate, the method comprises providing a substrate body with a surface of the substrate body having the pixel unit areas; defining a dividing line on the substrate body; defining a dividing line on the substrate body; marking two sides of the auxiliary area as a predetermined displaying area and a predetermined shielding area, marking first regions in the predetermined displaying area, marking second regions in the predetermined shielding area, and marking third regions in other areas; and forming a shielding layer in each of the second regions and at least one third region.

### BACKGROUND OF INVENTION

### Field of Invention

The present invention relates to liquid crystal displays, and particularly to a method for manufacturing a color filter substrate.

### Description of Prior Art

Liquid crystal display panel industry has experienced decades of development, where a shielding layer is used to shield pixel units, and a liquid crystal display panel with four rounded corners has become a new development. However, when a user views the display panel, user will view a boundary of the rounded corners as a zigzag, thus making a poor display effect.

### SUMMARY OF INVENTION

The application mainly provides a method for manufacturing a color filter substrate with a good display effect.

A method for manufacturing a color filter substrate, a surface of the color filter substrate comprising a plurality of pixel unit areas, each of which is corresponding to one pixel unit of an array substrate, the method comprises:

providing a substrate body, wherein a surface of the substrate body comprises the pixel unit areas, each of the pixel unit areas comprises three sub pixel areas including a red sub pixel area, a green sub pixel area, and a blue sub pixel area, all of which have an identical height and an identical area;

defining a dividing line on the substrate body, wherein the dividing line is a smooth curve;

defining an auxiliary area according to the dividing line, wherein the auxiliary area extends along the dividing line, and the dividing line passes through the auxiliary area;

marking one side of the auxiliary area as a predetermined displaying area, marking each of the pixel unit areas arranged in the predetermined displaying area as a first region, marking the other side of the auxiliary area as a predetermined shielding area, marking each of the pixel unit areas arranged in the predetermined shielding area as a second region, and marking each of the pixel unit areas having a part arranged in the auxiliary area as a third region; and

forming a shielding layer in each of the second regions and at least one third region.

In the method for manufacturing the color filter substrate, the method further comprises:

marking a plurality of first sub regions and a plurality of second sub regions in the third regions, a part of each of the first sub regions is arranged in the auxiliary area, the other part thereof is arranged in the predetermined shielding area, a part of each of the second sub regions is arranged in the auxiliary area, and the other part thereof is arranged in the predetermined displaying area; and

the step of forming the shielding layer in each of the second regions and at least one third region comprises: forming the shielding layer in each of the second regions and the first sub region of each of the third regions.

In the method for manufacturing the color filter substrate, the method further comprises:

marking a plurality of third sub regions in the third regions, each of the third sub regions comprises a first part, a second part, and a third part, the first part is arranged in the predetermined displaying area, the second part is arranged in the auxiliary area, and the third part is arranged in the predetermined shielding area; and

the step of forming the shielding layer in each of the second regions and at least one third region comprises: forming the shielding layer in each of the second regions, the first sub region of each of the third regions, and the third sub region of at least one of the third regions.

In the method for manufacturing the color filter substrate, in the third sub region of the third region, the shielding layer is formed when an area of the first part of the third sub region is less than one third of the maximum of the areas of the sub pixel areas of the third sub regions.

In the method for manufacturing the color filter substrate, in the third sub region of the third region, the shielding layer is formed when an area of the third part of the third sub region is greater than one third of the maximum of the areas of the sub pixel areas of the third sub regions.

In the method for manufacturing the color filter substrate, in the third sub region of the third region, the shielding layer is formed when the area of the third part of the third sub region is greater than the area of the first part of the third sub region.

In the method for manufacturing the color filter substrate, the auxiliary area has a first boundary line and a second boundary line, the second boundary line faces the predetermined shielding area, a distance between the first boundary line and the second boundary line is a width of the auxiliary area, and the width of the auxiliary area is greater than or equal to the maximum of the heights of the sub pixel areas and less than a length of a diagonal line of the pixel unit.

In the method for manufacturing the color filter substrate, a distance between the first boundary line and the dividing line is equal to a distance between the second boundary line and the dividing line.

In the method for manufacturing the color filter substrate, the shielding layer is formed when a length of a normal line from a vertex of the third sub region close to the first boundary line to the first boundary line is less than a length of a normal line from a vertex of the third sub region close to the second boundary line to the second boundary line.

A method for manufacturing a color filter substrate, a surface of the color filter substrate comprising a plurality of pixel unit areas, each of which is corresponding to one pixel unit of an array substrate, the method comprises:

providing a substrate body, wherein a surface of the substrate body comprises the pixel unit areas, each of the pixel unit areas comprises three sub pixel areas including a red sub pixel area, a green sub pixel area, and a blue sub pixel area;

defining a dividing line on the substrate body, wherein the dividing line is a smooth curve;

defining an auxiliary area according to the dividing line, wherein the auxiliary area extends along the dividing line, and the dividing line passes through the auxiliary area;

marking one side of the auxiliary area as a predetermined displaying area, marking each of the pixel unit areas arranged in the predetermined displaying area as a first region, marking the other side of the auxiliary area as a predetermined shielding area, marking each of the pixel unit areas arranged in the predetermined shielding area as a second region, and marking each of the pixel unit areas having a part arranged in the auxiliary area as a third region; and

forming a shielding layer in each of the second regions and at least one third region.

In the method for manufacturing the color filter substrate, the method further comprises:

marking a plurality of first sub regions and a plurality of second sub regions in the third regions, a part of each of the first sub regions is arranged in the auxiliary area, the other part thereof is arranged in the predetermined shielding area, a part of each of the second sub regions is arranged in the auxiliary area, and the other part thereof is arranged in the predetermined displaying area; and

the step of forming the shielding layer in each of the second regions and at least one third region comprises: forming the shielding layer in each of the second regions and the first sub region of each of the third regions.

In the method for manufacturing the color filter substrate, the method further comprises:

marking a plurality of third sub regions in the third regions, each of the third sub regions comprises a first part, a second part, and a third part, the first part is arranged in the predetermined displaying area, the second part is arranged in the auxiliary area, and the third part is arranged in the predetermined shielding area; and

the step of forming the shielding layer in each of the second regions and at least one third region comprises: forming the shielding layer in each of the second regions, the first sub region of each of the third regions, and the third sub region of at least one of the third regions.

In the method for manufacturing the color filter substrate, in the third sub region of the third region, the shielding layer is formed when an area of the first part of the third sub region is less than one third of the maximum of the areas of the sub pixel areas of the third sub regions.

In the method for manufacturing the color filter substrate, in the third sub region of the third region, the shielding layer is formed when an area of the third part of the third sub region is greater than one third of the maximum of the areas of the sub pixel areas of the third sub regions.

In the method for manufacturing the color filter substrate, in the third sub region of the third region, the shielding layer is formed when the area of the third part of the third sub region is greater than the area of the first part of the third sub region.

In the method for manufacturing the color filter substrate, the auxiliary area has a first boundary line and a second boundary line, the second boundary line faces the predetermined shielding area, a distance between the first boundary line and the second boundary line is a width of the auxiliary area, and the width of the auxiliary area is greater than or equal to the maximum of the heights of the sub pixel areas and less than a length of a diagonal line of the pixel unit.

In the method for manufacturing the color filter substrate, a distance between the first boundary line and the dividing line is equal to a distance between the second boundary line and the dividing line.

In the method for manufacturing the color filter substrate, the shielding layer is formed when a length of a normal line from a vertex of the third sub region close to the first boundary line to the first boundary line is less than a length of a normal line from a vertex of the third sub region close to the second boundary line to the second boundary line.

A method for manufacturing a color filter substrate, a surface of the color filter substrate comprising a plurality of pixel unit areas, each of which is corresponding to one pixel unit of an array substrate, the method comprises:

providing a substrate body, wherein a surface of the substrate body comprises the pixel unit areas;

defining a dividing line on the substrate body, wherein the dividing line is a smooth curve;

defining an auxiliary area according to the dividing line, wherein the auxiliary area extends along the dividing line, and the dividing line passes through the auxiliary area;

marking one side of the auxiliary area as a predetermined displaying area, marking each of the pixel unit areas arranged in the predetermined displaying area as a first region, marking the other side of the auxiliary area as a predetermined shielding area, marking each of the pixel unit areas arranged in the predetermined shielding area as a second region, and marking each of the pixel unit areas having a part arranged in the auxiliary area as a third region; and

forming a shielding layer in each of the second regions and at least one third region.

In the method for manufacturing the color filter substrate, the method further comprising:

marking a plurality of first sub regions and a plurality of second sub regions in the third regions, a part of each of the first sub regions is arranged in the auxiliary area, the other part thereof is arranged in the predetermined shielding area, a part of each of the second sub regions is arranged in the auxiliary area, and the other part thereof is arranged in the predetermined displaying area; and

the step of forming the shielding layer in each of the second regions and at least one third region comprises: forming the shielding layer in each of the second regions and the first sub region of each of the third regions.

In the method for manufacturing the color filter substrate of this application, a dividing line and an auxiliary area are defined to classify pixel unit, each first region is defined in a predetermined displaying area, each second region is defined in a predetermined shielding area, and a part of each third region is defined in the auxiliary area, and a shielding layer is formed in each of the second regions and at least one third region to accurately control the shielding layer to make a boundary of the shielding layer closed to the dividing line and to make a boundary of a rounded corner as a zigzag to be imperceptible to make a good display effect.

### BRIEF DESCRIPTION OF DRAWINGS

FIG. 1 is a planform of a substrate body according to one exemplary embodiment of the present disclosure.

FIG. 2 is a structure diagram of pixel units of a color filter substrate according to a first exemplary embodiment of the present disclosure.

FIG. 3 is a structure diagram of pixel units of a color filter substrate according to a second exemplary embodiment of the present disclosure.

FIG. 4 is a planform of a method for manufacturing a color filter substrate of FIG. 1 according to a first exemplary embodiment of the present disclosure.

FIG. 5 is a planform of a method for manufacturing a color filter substrate of FIG. 1 according to a second exemplary embodiment of the present disclosure.

FIG. 6 is a planform of a method for manufacturing a color filter substrate of FIG. 1 according to a third exemplary embodiment of the present disclosure.

### DETAILED DESCRIPTION OF PREFERRED EMBODIMENTS

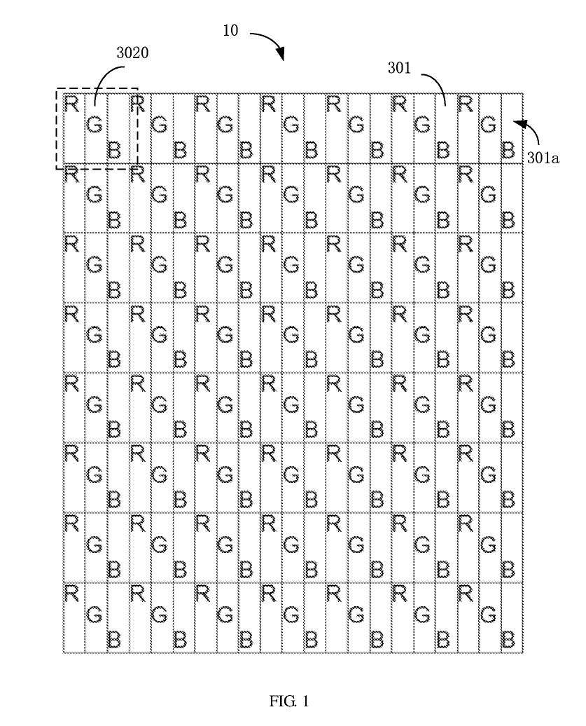

Referring to FIGS. 1-3, this application provides a method for manufacturing a color filter substrate 10. A surface 10 of the color filter substrate comprises a plurality of pixel unit areas 3020. Each of the pixel unit areas 3020 corresponds to one pixel unit of an array substrate.

First, a substrate body 301 is provided. A surface 301a of the substrate body 301 comprises the pixel unit areas 3020. Each of the pixel unit areas 3020 comprises three of a red, a green, and a blue sub pixel area 3021.

The substrate body 301 can be a glass substrate.

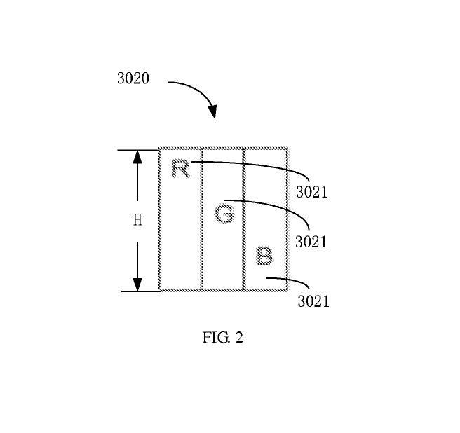

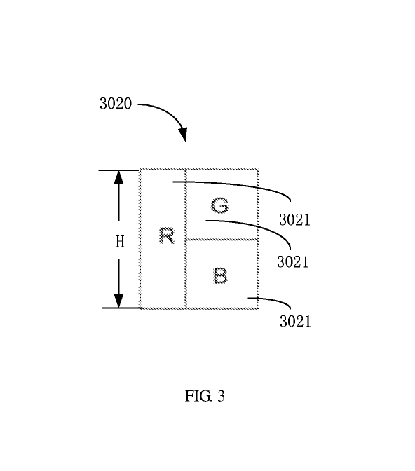

The three sub pixel areas 3021 of each of the pixel unit areas 3020 can be arranged by many different arrangement methods. Referring to FIG. 2, the sub pixel areas 3021 have an identical height and an identical area. Among the sub pixel areas 3021, maximum of heights of the sub pixel areas is a height of the red sub pixel area 3021. Among the sub pixel areas 3021, maximum of areas of the sub pixel areas 3021 is an area of the red sub pixel area 3021. Referring to FIG. 3, sum of a height of the green sub pixel area 3021 and a height of the blue sub pixel area 3021 are equal to a height of the red sub pixel area 3021. Among the sub pixel areas 3021, maximum of heights of the sub pixel areas 3021 is a height of the red sub pixel area 3021. Among the sub pixel areas 3021, maximum of areas of the sub pixel areas 3021 is an area of the red sub pixel area 3021.

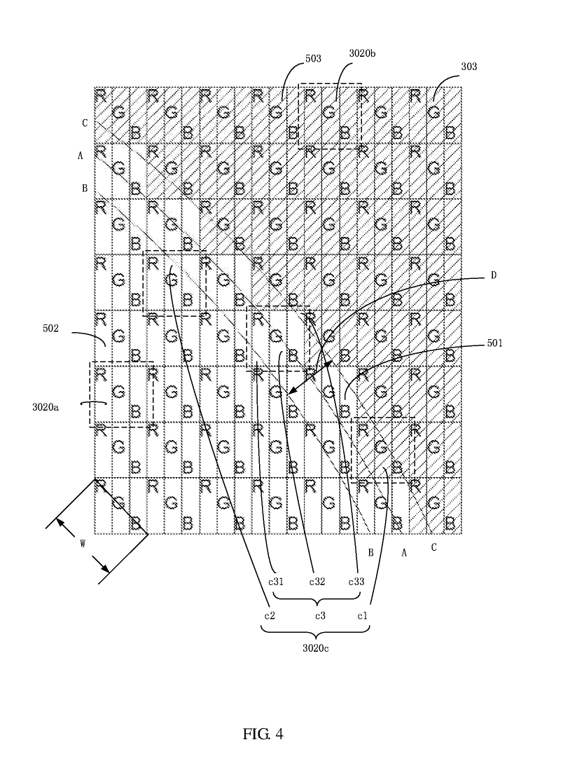

Second, referring to FIG. 4, a dividing line A-A is defined on the substrate body 301a. The dividing line A-A is a smooth curve.

Third, according to the dividing line A-A, an auxiliary area 501 is defined. The auxiliary area 501 extends along the dividing line A-A, and the dividing line A-A passes through the auxiliary area 501.

Fourth, one side of the auxiliary area 501 is marked as a predetermined displaying area 502. Each of the pixel unit areas 3020 arranged in the predetermined displaying area 502 is marked as a first region 3020a. The other side of the auxiliary area 501 is marked as a predetermined shielding area 503. Each of the pixel unit areas 3020 arranged in the predetermined shielding area 503 is marked as a second region 3020b. Each of the pixel unit areas 3020 having a part arranged in the auxiliary area 501 is marked as a third region 3020c.

In one exemplary embodiment, a plurality of first sub regions c1 and a plurality of second sub regions c2 are marked in the third region 3020c. A part of each of the first sub regions c1 is arranged in the auxiliary area 501, and the other part is arranged in the predetermined shielding area 503. A part of each of the second sub regions c2 is arranged in the auxiliary area 501, and the other part is arranged in the predetermined displaying area 502.

In one exemplary embodiment, the third regions 3020c can further comprise a plurality of third sub regions c3. A first part c31 of each of the third sub regions c3 is arranged in the predetermined displaying area 501, a second part c32 is arranged in the auxiliary area 502, and a third part c33 is arranged in the predetermined shielding area 503.

The auxiliary area 3020c has a first boundary line B-B and a second boundary line C-C. The first boundary line B-B faces the predetermined displaying area 501. The second boundary line C-C faces the predetermined shielding area 503. A distance between the first boundary line B-B and the second boundary line C-C is a width D of the auxiliary area 501.

In one exemplary embodiment, the width D of the auxiliary area 501 can be equal to the maximum of the heights of the sub pixel areas. In one exemplary embodiment, the width D of the auxiliary area 501 can be greater than the maximum of the heights of the sub pixel areas and less than a length W of a diagonal line of the pixel unit area. In one exemplary embodiment, a distance between the first boundary line B-B and the dividing line A-A is equal to a distance between the second boundary line C-C and the dividing line A-A.

Finally, referring to FIGS. 4-6, a shielding layer 303 is formed in each of the second regions 3020b and at least one third region 3020c.

In one exemplary embodiment, referring to FIG. 4, the shielding layer 303 is formed in each of the second regions 3020b and the first sub region c1 of each of the third regions 3020c.

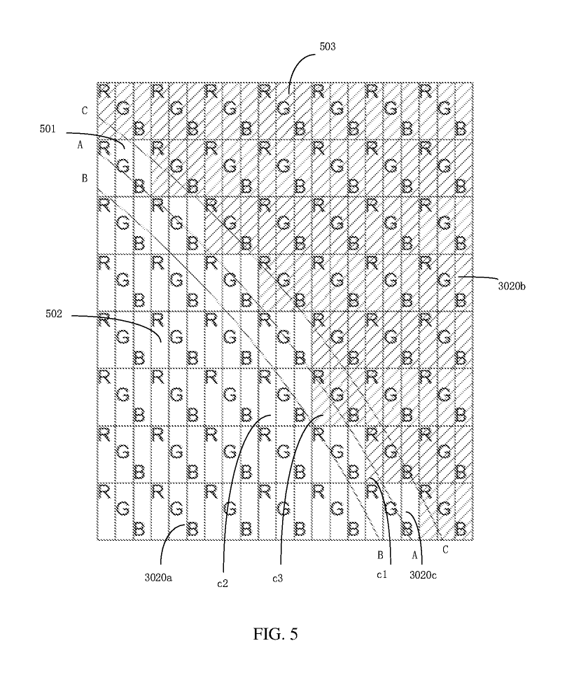

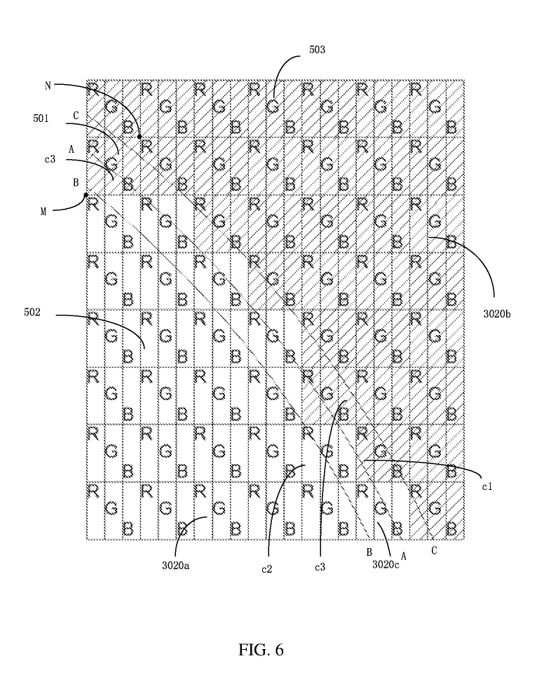

In one exemplary embodiment, referring to FIGS. 5-6, the shielding layer 303 is formed in each of the second regions 3020b, the first sub region c1 of each of the third regions 3020c, and the third sub region c3 of at least one of the third region 3020c.

In the third sub region c3 of the third region 3020c, the shielding layer 303 can be formed when an area of the first part c31 of the third sub region c3 is less than one third of the maximum of the areas of the sub pixel area 3021 of the third sub region c3.

In the third sub region c3 of the third region 3020c, the shielding layer 303 can be formed when an area of the third part c33 of the third sub region c3 is greater than one third of the maximum of the areas of the sub pixel area 3021 of the third sub region c3.

In the third sub region c3 of the third region 3020c, the shielding layer 303 can be formed when the area of the third part c33 of the third sub region c3 is greater than the area of the first part c31 of the third sub region c3.

In the third sub region c3 of the third region 3020c, the shielding layer 303 can be formed when a length of a normal line from a vertex M of the third sub region c3 close to the first boundary line B-B to the first boundary line B-B is less than a length of a normal line from a vertex M of the third sub region c3 close to the second boundary line C-C to the second boundary line C-C.

In the method for manufacturing the color filter substrate of this application, a dividing line and an auxiliary area are defined to classify pixel unit, each first region is defined in a predetermined displaying area, each second region is defined in a predetermined shielding area, and a part of each third region is defined in the auxiliary area, and a shielding layer is formed in each of the second regions and at least one third region to accurately control the shielding layer to make a boundary of the shielding layer close to the dividing line and to make a boundary of a rounded corner as a zigzag to be imperceptible to make a good display effect.

In conclusion, the present disclosure is described in detail in accordance with the above contents with the specific preferred examples. However, this present disclosure is not limited to the specific examples. For a person of ordinary skill in the art, on the premise of keeping the conception of the present disclosure, the technical personnel can also make simple deductions or replacements, all of which should be considered to belong to the protection scope of the present disclosure.

1. A method for manufacturing a color filter substrate, a surface of the color filter substrate comprising a plurality of pixel unit areas, each of the pixel unit areas is corresponding to one pixel unit of an array substrate, the method comprising:
providing a substrate body, wherein a surface of the substrate body comprises the pixel unit areas, each of the pixel unit areas comprises three sub pixel areas including a red sub pixel area, a green sub pixel area, and a blue sub pixel area, all of the red sub pixel area, the green sub pixel area, and the blue sub pixel area have an identical height and an identical area;
defining a dividing line on the substrate body, wherein the dividing line is a smooth curve;
defining an auxiliary area according to the dividing line, wherein the auxiliary area extends along the dividing line, and the dividing line passes through the auxiliary area;
marking one side of the auxiliary area as a predetermined displaying area, marking each of the pixel unit areas arranged in the as a first region, marking the other side of the auxiliary area as a predetermined shielding area, marking each of the pixel unit areas arranged in the predetermined shielding area as a second region, and marking each of the pixel unit areas having a part arranged in the auxiliary area as a third region; and
forming a shielding layer in each of the second regions and at least one third region.

2. The method for manufacturing the color filter substrate of claim 1, further comprising:
marking a plurality of first sub regions and a plurality of second sub regions in the third regions, a part of each of the first sub regions is arranged in the auxiliary area, the other part of the first sub region is arranged in the predetermined shielding area, a part of each of the second sub regions is arranged in the auxiliary area, and the other part of the second sub region is arranged in the predetermined displaying area; and
the step of forming the shielding layer in each of the second regions and at least one third region comprises: forming the shielding layer in each of the second regions and the first sub region of each of the third regions.

3. The method for manufacturing the color filter substrate of claim 1, further comprising:
marking a plurality of third sub regions in the third regions, each of the third sub regions comprises a first part, a second part, and a third part, the first part is arranged in the predetermined displaying area, the second part is arranged in the auxiliary area, and the third part is arranged in the predetermined shielding area; and
the step of forming the shielding layer in each of the second regions and at least one third region comprises: forming the shielding layer in each of the second regions, the first sub region of each of the third regions, and the third sub region of at least one of the third regions.

4. The method for manufacturing the color filter substrate of claim 3, wherein in the third sub region of the third region, the shielding layer is formed when an area of the first part of the third sub region is less than one third of the maximum of the areas of the sub pixel areas of the third sub regions.

5. The method for manufacturing the color filter substrate of claim 3, wherein in the third sub region of the third region, the shielding layer is formed when an area of the third part of the third sub region is greater than one third of the maximum of the areas of the sub pixel areas of the third sub regions.

6. The method for manufacturing the color filter substrate of claim 3, wherein in the third sub region of the third region, the shielding layer is formed when the area of the third part of the third sub region is greater than the area of the first part of the third sub region.

7. The method for manufacturing the color filter substrate of claim 3, wherein the auxiliary area has a first boundary line and a second boundary line, the second boundary line faces the predetermined shielding area, a distance between the first boundary line and the second boundary line is a width of the auxiliary area, and the width of the auxiliary area is greater than or equal to the maximum of the heights of the sub pixel areas and less than a length of a diagonal line of the pixel unit area.

8. The method for manufacturing the color filter substrate of claim 7, wherein a distance between the first boundary line and the dividing line is equal to a distance between the second boundary line and the dividing line.

9. The method for manufacturing the color filter substrate of claim 7, wherein in the third sub region of the third region, the shielding layer is formed when a length of a normal line from a vertex of the third sub region close to the first boundary line to the first boundary line is less than a length of a normal line from a vertex of the third sub region close to the second boundary line to the second boundary line.

10. A method for manufacturing a color filter substrate, a surface of the color filter substrate comprising a plurality of pixel unit areas, each of the pixel unit areas is corresponding to one pixel unit of an array substrate, the method comprising:
providing a substrate body, wherein a surface of the substrate body comprises the pixel unit areas, each of the pixel unit areas comprises three sub pixel areas including a red sub pixel area, a green sub pixel area, and a blue sub pixel area;
defining a dividing line on the substrate body, wherein the dividing line is a smooth curve;
defining an auxiliary area according to the dividing line, wherein the auxiliary area extends along the dividing line, and the dividing line passes through the auxiliary area;
marking one side of the auxiliary area as a predetermined displaying area, marking each of the pixel unit areas arranged in the predetermined displaying area as a first region, marking the other side of the auxiliary area as a predetermined shielding area, marking each of the pixel unit areas arranged in the predetermined shielding area as a second region, and marking each of the pixel unit areas having a part arranged in the auxiliary area as a third region; and
forming a shielding layer in each of the second regions and at least one third region.

11. The method for manufacturing the color filter substrate of claim 10, further comprising:
marking a plurality of first sub regions and a plurality of second sub regions in the third regions, a part of each of the first sub regions is arranged in the auxiliary area, the other part of the first sub region is arranged in the predetermined shielding area, a part of each of the second sub regions is arranged in the auxiliary area, and the other part of the second sub region is arranged in the predetermined displaying area; and
the step of forming the shielding layer in each of the second regions and at least one third region comprises: forming the shielding layer in each of the second regions and the first sub region of each of the third regions.

12. The method for manufacturing the color filter substrate of claim 11, further comprising:
marking a plurality of third sub regions in the third regions, each of the third sub regions comprises a first part, a second part, and a third part, the first part is arranged in the predetermined displaying area, the second part is arranged in the auxiliary area, and the third part is arranged in the predetermined shielding area; and
the step of forming the shielding layer in each of the second regions and at least one third region comprises: forming the shielding layer in each of the second regions, the first sub region of each of the third regions, and the third sub region of at least one of the third regions.

13. The method for manufacturing the color filter substrate of claim 12, wherein in the third sub region of the third region, the shielding layer is formed when an area of the first part of the third sub region is less than one third of the maximum of the areas of the sub pixel areas of the third sub regions.

14. The method for manufacturing the color filter substrate of claim 12, wherein in the third sub region of the third region, the shielding layer is formed when an area of the third part of the third sub region is greater than one third of the maximum of the areas of the sub pixel areas of the third sub regions.

15. The method for manufacturing the color filter substrate of claim 12, wherein in the third sub region of the third region, the shielding layer is formed when the area of the third part of the third sub region is greater than the area of the first part of the third sub region.

16. The method for manufacturing the color filter substrate of claim 12, wherein the auxiliary area has a first boundary line and a second boundary line, the second boundary line faces the predetermined shielding area, a distance between the first boundary line and the second boundary line is a width of the auxiliary area, and the width of the auxiliary area is greater than or equal to the maximum of the heights of the sub pixel areas and less than a length of a diagonal line of the pixel unit area.

17. The method for manufacturing the color filter substrate of claim 16, wherein a distance between the first boundary line and the dividing line is equal to a distance between the second boundary line and the dividing line.

18. The method for manufacturing the color filter substrate of claim 16, wherein in the third sub region of the third region, the shielding layer is formed when a length of a normal line from a vertex of the third sub region close to the first boundary line to the first boundary line is less than a length of a normal line from a vertex of the third sub region close to the second boundary line to the second boundary line.

19. A method for manufacturing a color filter substrate, a surface of the color filter substrate comprising a plurality of pixel unit areas, each of the pixel unit areas is corresponding to one pixel unit of an array substrate, the method comprising:
providing a substrate body, wherein a surface of the substrate body comprises the pixel unit areas;
defining a dividing line on the substrate body, wherein the dividing line is a smooth curve;
defining an auxiliary area according to the dividing line, wherein the auxiliary area extends along the dividing line, and the dividing line passes through the auxiliary area;
marking one side of the auxiliary area as a predetermined displaying area, marking each of the pixel unit areas arranged in the predetermined displaying area as a first region, marking the other side of the auxiliary area as a predetermined shielding area, marking each of the pixel unit areas arranged in the predetermined shielding area as a second region, and marking each of the pixel unit areas having a part arranged in the auxiliary area as a third region; and
forming a shielding layer in each of the second regions and at least one third region.

20. The method for manufacturing the color filter substrate of claim 19, further comprising:
marking a plurality of first sub regions and a plurality of second sub regions in the third regions, a part of each of the first sub regions is arranged in the auxiliary area, the other part of the first sub region is arranged in the predetermined shielding area, a part of each of the second sub regions is arranged in the auxiliary area, and the other part of the second sub region is arranged in the predetermined displaying area; and
the step of forming the shielding layer in each of the second regions and at least one third region comprises: forming the shielding layer in each of the second regions and the first sub region of each of the third regions.
